(19) United States
(12) Patent Application Publication
(10) Pub. No.: US 2011/0040545 A1
(43) Pub. Date: Feb. 17, 2011

(54) METHOD TO CHARACTERIZE A PROTEIN AS RNA BINDING PROTEIN

(75) Inventors: Naveen Kulkarni, Karnataka (IN); Vidya Niranjan, Karnataka (IN)

Correspondence Address: FOLEY AND LARDNER LLP;SUITE 500, 3000 K STREET NW, WASHINGTON, DC, 20007, US

(73) Assignee: Polyclone Bioservices Pvt. Ltd.

(21) Appl. No.: 12/863,302

(22) PCT Filed: Jan. 19, 2009
(86) PCT No.: PCT/IN09/00047

§ 371 Date: Oct. 29, 2010

(30) Foreign Application Priority Data
Jan. 17, 2008 (IN) 00146/CHE/2008

(51) Int. Cl. G06G 7/58; G06G 7/60

(52) U.S. Cl. 703/11

(57) ABSTRACT

The invention relates to a method to characterize a protein as RNA-binding protein, said method comprising steps of: a) modeling the protein using a template structure; b) analyzing the modeled protein for RNA-binding site(s); and c) docking the analyzed modeled protein with polyadenylated RNA using co-ordinates of RNA complexed with polyadenide binding for said chacterisation. The invention especially relates to a method to characterize Gamma-glutamyl transpeptidase (GGT) as RNA-binding protein, said method comprising steps of: a) modeling the GGT using a template structure; b) analyzing the modeled GGT for RNA-binding site(s); and c) docking the analyzed modeled GGT with polyadenylated RNA using coordinates of RNA complexed with polyadenide protein for said characterisation.

### FIELD OF THE INVENTION

The present invention relates to a method to characterize a protein as RNA-binding protein. More particularly, it relates to a method to characterize Gamma-glutamyl transpeptidase (GGT) as an RNA-binding protein.

### BACKGROUND AND PRIOR ART OF THE INVENTION

Gamma-Glutamyl transpeptidase (GGT) is a cell surface glycoprotein that cleaves gamma-glutamyl amide bonds. It initiates the cleavage of extracellular glutathione into its constituent amino acids which can then be transported into the cell and is thus involved in Glutathione homeostasis.

GGT plays a major role in tumor cell biology, tumor drug resistance and reconstitution of cellular antioxidant/antitoxic defenses. Researchers have examined the relationship between GGT expression in melanoma cell lines and its relationship to intra- and extra-cellular thiol metabolism. Also, it was concluded that GGT levels have profound influence on tumor cells to drug sensitivity. Studies have indicated that cisplatin resistance is a consequence of modifications of cellular pharmacokinetics as a result of extracellular drug inactivation by thiol metabolites originated by GGT-mediated GSH cleavage rather than due to intracellular levels of glutathione. Further, it was discovered that membrane GGT activity can facilitate oxidation of extracellular ascorbic acid and promote its uptake efficiently of vitamin C. GGT activity is not necessary for the antitumor activity of cisplatin and further suggested that inhibition of GGT would be beneficial.

Though GGT is expressed at high levels in many human tumors, the reason for this increase is not entirely clear. Most of the work in the prior art is focused on the role of GGT as a biomarker for cancer. Further, no additional biochemical role for this protein has been suggested in the prior art. The present invention overcomes the limitation associated with the prior art.

### OBJECTS OF THE INVENTION

The main object of the present invention is to develop a method to characterize GGT as an RNA-binding protein.

Another main object of the present invention is to develop a method to characterize a protein as RNA-binding protein.

Yet another object of the present invention is to apply this methodology for any downstream RNA binders that could be used as biomarkers of disease.

Still another main object of the present invention is to apply this method for early-stage detection and/or classification of cancer as well as any drug targets thereof.

Still another object of the present invention is to develop a method to identify RNA's bound to GGT as useful biomarkers or drug targets

### STATEMENT OF THE INVENTION

Accordingly, the present invention relates to a method to characterize a protein as RNA-binding protein, said method comprising steps of: (a) modeling the protein using a template structure; (b) analyzing the modeled protein for RNA-binding site(s); and (c) docking the analyzed modeled protein with polyadenylated RNA using co-ordinates of RNA complexed with polyadenine binding protein for said characterisation; a method to characterize Gamma-glutamyl transpeptidase (GGT) as RNA-binding protein, said method comprising steps of: (a) modeling the GGT using a template structure; (b) analyzing the modeled GGT for RNA-binding site(s); and (c) docking the analyzed modeled GGT with polyadenylated RNA using co-ordinates of RNA complexed with polyadenine binding protein for said characterisation; and a method to identify RNA's bound to GGT as useful biomarkers or drug targets, said method comprising steps of: (a) modeling the GGT using a template structure and to obtain co-ordinates of PABP complexed with RNA, and (b) docking polyadenylated RNA with co-ordinates of modeled GGT to identify RNA bound to GGT as useful biomarkers or drug targets.

### BRIEF DESCRIPTION OF ACCOMPANYING DRAWINGS

FIG. 1: R-bind-prediction of RNA binding by GGT light chain.

FIG. 2: R bind results indicating 4 arginine residues of light chain of GGT which potentially bind poly A tail of RNA.

FIG. 3a: Shows orientation of RNA with 1CVJ.

FIG. 3b: Shows the orientation of RNA (Poly A) alone.

FIG. 4: Shows result of light chain GGT binding Poly A tail of RNA using HEX software

FIG. 5: Shows the interaction point vanderwaal radius of poly A and light chain of GGT using VEGA.

FIG. 6: Illustrates the point of contact of light chain of GGT with the Poly A tail of RNA using SwissPDB viewer.

FIG. 7: Illustrates the docking results and the point of interaction of GGT with RNA. The light chain has ARG169 which has contact with Poly A tail of RNA.

FIG. 8: Western blot to check the binding of antibodies sc-20638, sc-100746, ab55138 to GGT

A. sc-20638; B. sc-100746; C. ab55138

FIG. 9: A. One-step 1P western using ab55138; B. Traditional western using sc-100746.

FIG. 10: Results of Microarray data:

### ST_G10_IP_{—}12292008.CEL(normalized)—Green

### ST_GGT_IP_{—}12292008.CEL(normalized)—Orange

ST_GGT_Input_{—}12292008.CEL(normalized)—Yellow color

Red indicates enrichment, green indicates lack of enrichment relative to input (yellow).

### DETAILED DESCRIPTION OF THE INVENTION

The present invention relates to a method to characterize a protein as RNA-binding protein, said method comprising steps of:
a) modeling the protein using a template structure;
b) analyzing the modeled protein for RNA-binding site(s); and
c) docking the analyzed modeled protein with polyadenylated RNA using co-ordinates of RNA complexed with polyadenine binding protein for said characterisation.

In another embodiment of the present invention, the protein is modeled using modeling tools and servers, preferably jigsaw “interactive server”.

In still another embodiment of the present invention, the modeled protein is analyzed for RNA-binding site(s) using Rbind software.

In still another embodiment of the present invention, the method is useful in identifying RNA's that bind the protein which may prove useful as biomarkers or drug targets.

In still another embodiment of the present invention, the method is useful in early stage detection and/or classification of cancer.

The present invention relates to a method to characterize Gamma-glutamyl transpeptidase (GGT) as RNA-binding protein, said method comprising steps of:
a) modeling the GGT using a template structure;
b) analyzing the modeled GGT for RNA-binding site(s); and
c) docking the analyzed modeled GGT with polyadenylated RNA using coordinates of RNA complexed with polyadenine binding protein for said characterisation.

In still another embodiment of the present invention, the template structure is 2DG5 and its orthologs.

In still another embodiment of the present invention, the GGT is modeled using modeling tools and servers, preferably jigsaw “interactive server”.

In still another embodiment of the present invention, the modeled GGT is analyzed for RNA-binding site(s) using Rbind software.

In still another embodiment of the present invention, the RNA-binding site is present in light chain of GGT.

In still another embodiment of the present invention, the RNA-binding sites are arginine rich motifs of the light chain of GGT.

In still another embodiment of the present invention, the co-ordinates of RNA alone was taken from the structure ICVJ.

In still another embodiment of the present invention, the method is useful in identifying RNA's that bind the GGT which may prove useful as biomarkers or drug targets.

In still another embodiment of the present invention, the method is useful in early stage detection and/or classification of cancer.

The present invention relates to a method to identify RNA's bound to GGT as useful biomarkers or drug targets, said method comprising steps of:
a) modeling the GGT using a template structure and to obtain coordinates of PABP complexed with RNA, and
b) docking polyadenylated RNA with co-ordinates of modeled GGT to identify RNA bound to GGT as useful markers or drug targets.

In another embodiment of the present invention, the analyzed modeled GGT is docked with polyadenylated RNA's using co-ordinates of RNA complexed with a known polyadenine binding protein.

GGT is expressed at high levels in many human tumors and in many carcinogen-induced tumors. However, the reason for this increase is not clear. Further, no additional biochemical role for this protein has been suggested. Our bioinformatics analysis strongly suggests that this protein is also an RNA binding protein, with possible implications for tumor progression.

The present invention relates to a method to characterize Gamma-glutamyl transpeptidase (GGT) as RNA-binding protein, said method comprising steps of:
a) modeling the GGT using a template structure;
b) analyzing the modeled GGT for RNA-binding site(s); and
c) docking the analyzed modeled GGT with polyadenylated RNA using co-ordinates of RNA complexed with polyadenine binding protein for said characterisation.

The above method can also be used at characterizing macromolecules, particularly any protein. Here, the protein is modeled and analyzed for RNA binding sites. The analyzed modeled protein is then docked with polyadenylated RNA using the co-ordinates of RNA complexed with a polyadenine binding protein (already known complex) for said characterisation.

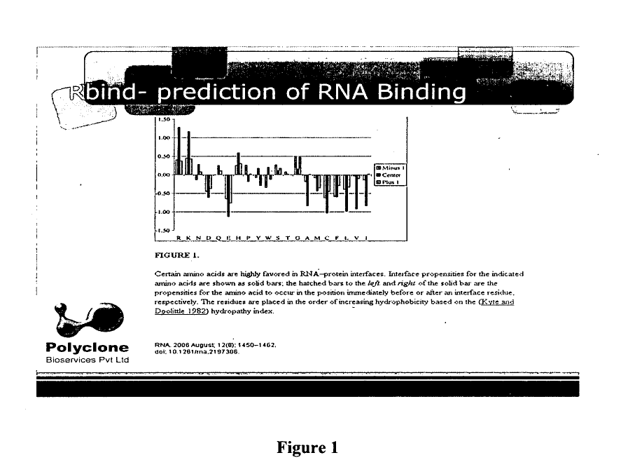

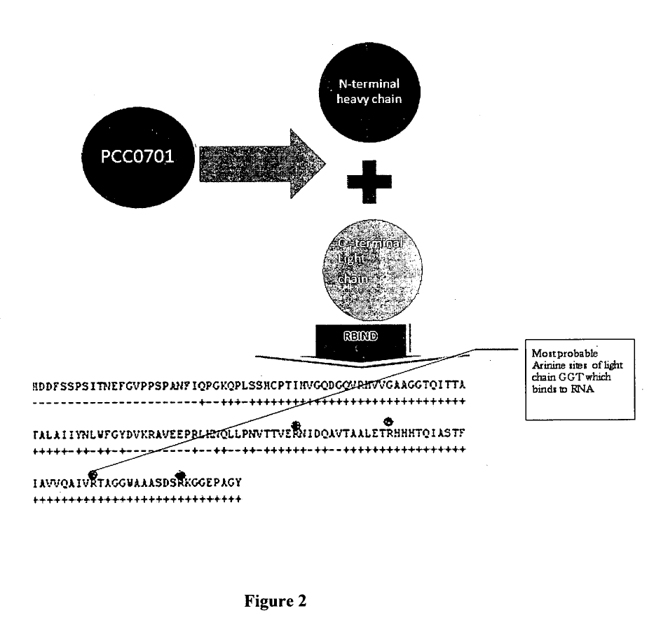

Thus, in the present invention, strong evidence that the protein (GGT) also has properties of RNA binding (FIGS. 1 and 2) is shown by in silico methodology. The role of GGT as RNA-binding protein would potentially help in classification and early stage detection of cancer.

GGT is isolated, purified and immunoprecipitated with other RNA-binding proteins (RBPs) which play a role in cancer pathway. On validation and confirmation, this is extended to RIP-ChIP technology. A micro array containing all the genes involved in cancer pathway is spotted and its expression levels are correlated with the presence of RBPs. The expression of both RBPs and the bound RNA will be analyzed and would be studied and standardized using microarrays for the type of cancer and also the stage of cancer. Markers identified and proven become a part of the diagnostic RIP-ChIP.

Since the human protein has not been characterized at the structural level, this protein was modeled and predicted that the C-terminal part is capable of binding RNA, by use of appropriate in silico tools. From the domain analysis, it was found that the active site residue is C-terminal to the autolytic cleavage site, a finding consistent with the proposed RNA binding activity since this part would be intracellular.

Bioinformatics approaches towards gene discovery and functions have become increasingly important. Use of such an approach is nearly essential in understanding the contribution of various genes in disease states, including cancer. Bioinformatics also plays a crucial role in discovery of novel protein functions.

The discovery of early stage cancer biomarkers would greatly enhance treatment options. While it is a major focus of research, few have been successfully identified. GGT, being expressed widely in various tumors is of use in this regard, since RNA's binding to this protein could be potentially good markers.

The invention is further elaborated with the help of following examples. However, these examples should not be construed to limit the scope of the invention.

### Example 1

The human GGT structure has not been solved experimentally and hence modeled using its sequence. It was checked with “CPH model 2 servers”. The E. coli protein has been experimentally characterized and was used as template (2EOW-PDB structure ID). This represents the crystal structure of the GGT consisting of L- and S-subunits with a mutant GGT, T391 A, that is unable to undergo autocatalytic processing. The above structure was energy minimized using grooms (swisspdb). The analyses of human GGT using the pro-protein template strongly indicated it to be an RBP. The tools used were similar to that used for analyzing it against the mature, processed E. coli GGT.

The mature protein is formed through posttranslational autolytic cleavage of the single chain precursor to form a heavy chain and light chain heterodimeric protein. Structural comparison of the precursor protein and mature GGT subunits demonstrates that the structures of the core regions in the two proteins are unchanged. However, marked differences are found near the active site and hence the light chain of human GGT protein was modeled using the template 2DG5 and jigsaw “interactive server”. This tool was shortlisted for selection of the template 2DG5 as well as to align only active light chain to investigate the RNA binding potential of GGT.

### Example 2

The light chain sequence of human GGT was used to analyze potential RNA binding sites with the “Rbind”, a software which works on hydrophobicity principle and hydropathy index to predict RNA interaction sites in any given protein (FIG. 1). The Rbind results indicated 4 arginine residues. Actually the orientation had 3 residues very close to RBP. Sequence level prediction will be the same even if we cut, only structural level confirmation gave the result which would potentially bind RNA (FIG. 2).

### Example 3

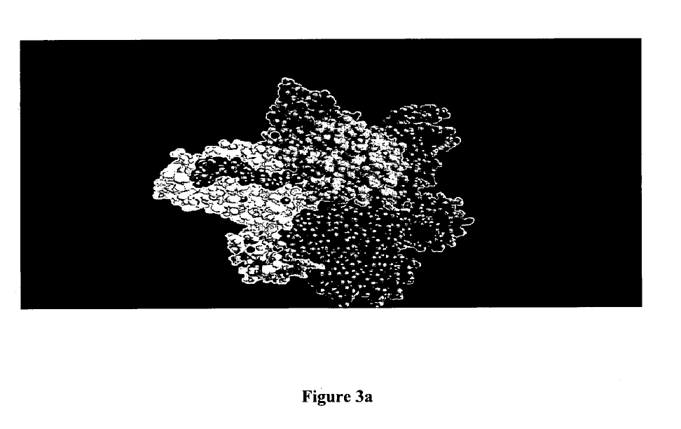

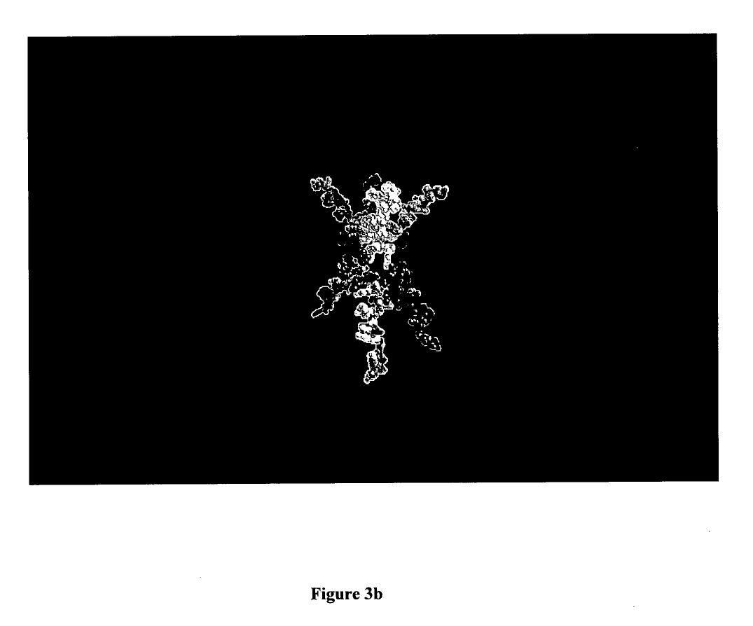

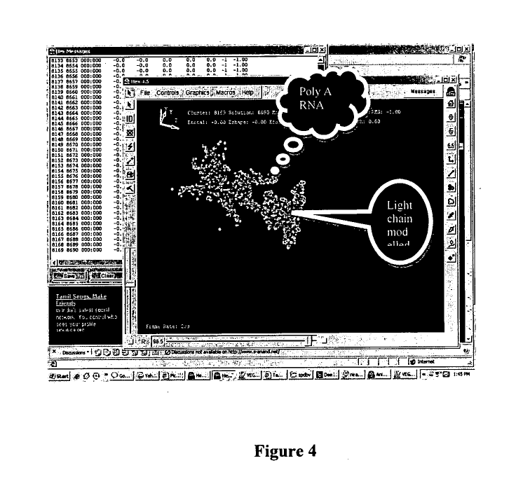

The structure of the light chain was docked with Polyadenylated RNA. Using bioinformatics techniques, the coordinates of RNA alone was taken from the structure 1 CVJ (Poly Adenylated RNA complexed with Polyadenine Binding Protein) as shown in FIGS. 3a and 3b. This facilitated the orientation of the RNA to be docked with modeled light chain GGT, using HEX software. Basically this technique allows one to see if the RNA fits well into the modeled light chain in a structurally similar way to other RBPs. The Hex docking results with minimum energy values confirmed the highly probable interaction between the GGT and RNA (FIG. 4). Using VEGA, the interaction point's vanderwaal radius of Poly A and GGT were found. This result further strengthened GGT as RBP (FIG. 5).

Further, the results were confirmed with Bioinformatics & Drug Design Group [BIDD]'s.

SVMProt. SVM prot predicts protein functional family. SVMProt classification system is trained from representative proteins of a number of functional families and seed proteins of Pfam curated protein families. It currently covers 54 functional families and additional families will be added in the near future. The computed accuracy for protein family classification is found to be in the range of 69-99.6%. SVMProt shows a certain degree of capability for the classification of distantly related proteins and homologous proteins of different function and thus may be used as a protein function prediction tool that complements sequence alignment methods.

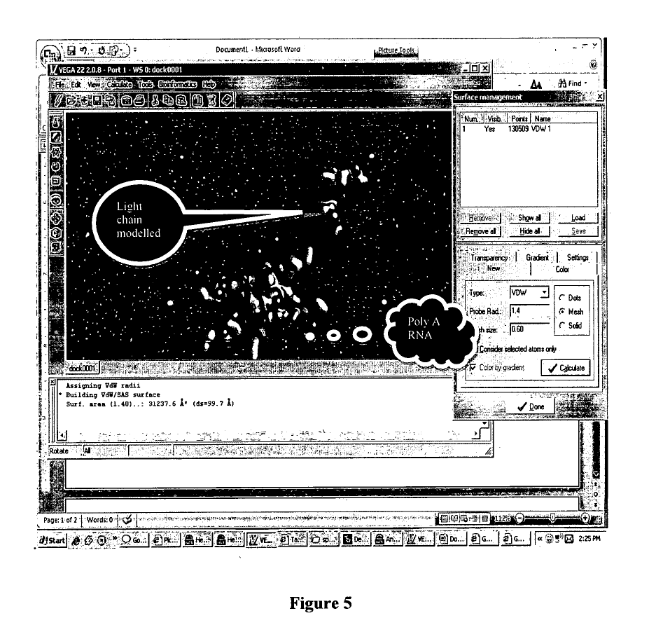

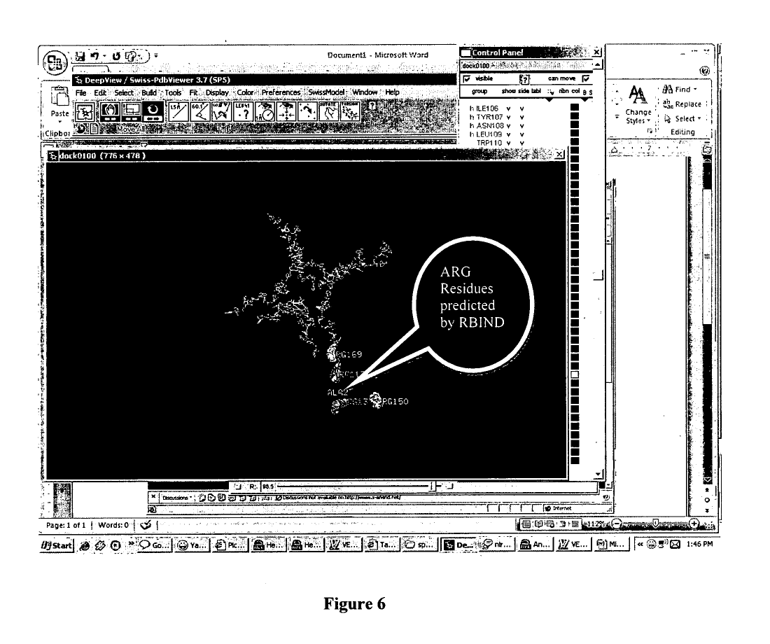

While the full GGT sequence fed into the vector machine did not show the RNA binding activity, the light chain alone when analysed similarly supported it belonging to the RBP family. The light chain ARG169 appears to make contact with the polyA tail of RNA (FIGS. 6 and 7).

The fact proved by in silico method that GGT is an RNA-binding protein is further confirmed by wet-lab experimentation. Further, it is also explored that there is a possibility that GGT maybe involved in regulation of gene expression through interaction with cellular mRNAs.

### Example 4

### Materials and Methods

Anti-GGT antibodies were purchased from Santa Cruz Biotechnology Inc. (catalog Nos. sc20638 and sc-100746) and Abcam Inc. (ab55138). Protein-A sepharose beads were from Sigma Chemical Co.-Western blots were performed using Ready gel Tris.HCl gels, and reagents from Bio-Rad. One-Step™ Complete IP-Western kit was from GenScript Corporation, NJ, Chemiluminiscent reagent SuperSignal West Femto was from Pierce Biotechnology (Thermofisher Scientific).

### Example 5

### Western Blot to Test the GGT Antibodies

Four commonly used cell lines (HeLa, HepG2, K562 and GM12878) were tested for presence of GGT. Cells were lysed in the Polysome Lysis buffer (2) and 40 μg total protein from each cell line was loaded on 7.5% SDS-PAGE. The antibody dilutions used were: sc-20638 (1:100), sc-100746 (1:100), ab55138 (1:1000). Western blots were visualized using Supersignal West Femto on AlphaImager.

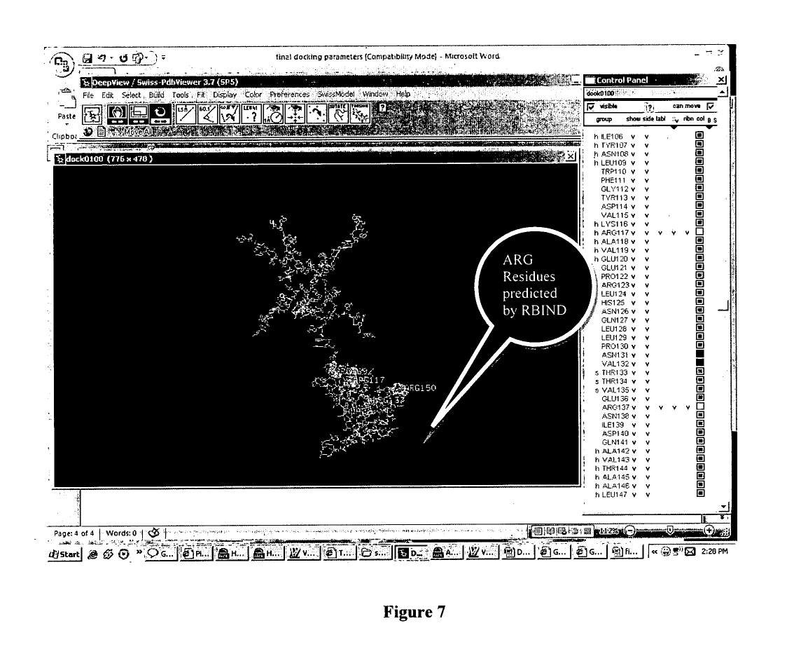

The predicted molecular weight of GGT is 64 KDa. As shown in FIG. 8, antibodies sc-100746 and ab55138 picked one strong band from each lysate.

### Example 6

RIP-CHIP analysis: Immunoprecipitation (IP) of GGT followed by analysis of any RNA(s) co-immunoprecipitated with it. Briefly, protein-A sepharose beads were coated with GGT antibodies (50 μl packed beads and 5 μg antibody), incubated with whole cell lysate from HepG2 (in polysome lysis buffer, ˜2.5 mg total protein) for three hours at 4° C. Beads were washed extensively to remove any non-specific binding. An aliquot was removed to test the efficiency of IP and the rest of the beads were subjected to proteinase K treatment to digest the protein and release the RNA. RNA was purified using standard phenol/chloroform extraction and ethanol precipitation. The immunoprecipitated RNA that is pulled down by GGT antibodies was then analyzed for quality on Nanodrop® spectrophotometer followed by analysis on an Agilent Bioanalyzer 2100.

The aliquot which has just the lysate, in the same binding buffer and at the same dilution as that mixed with beads is called input. This represents the starting material and is subjected to all the same treatments as the IP but without any proteinA-beads, (incubated for the same time at 4° C., subjected to same proteinase K and phenol chloroform extractions). This helps monitoring any RNAse contamination at any of the steps of the IP.

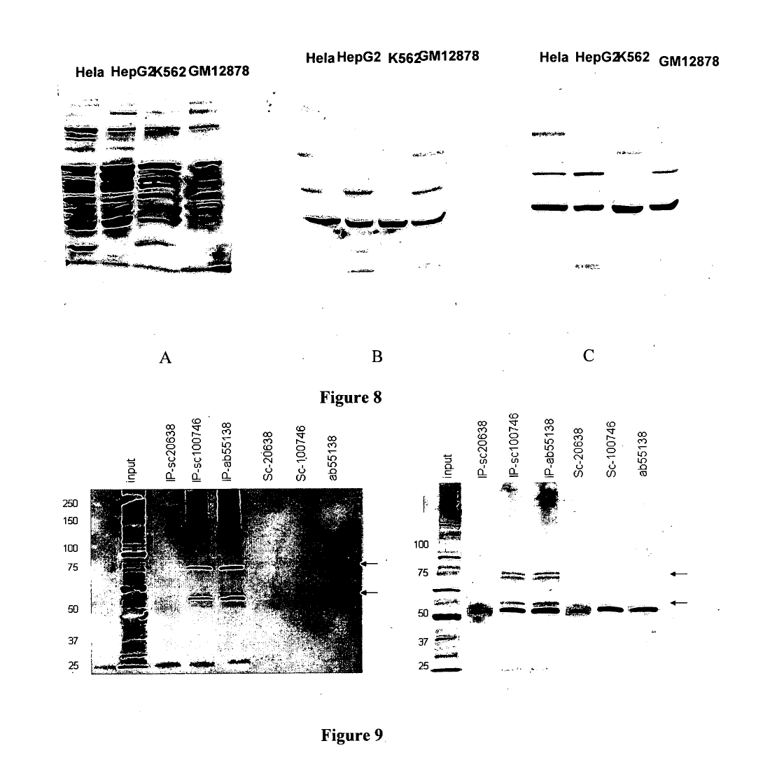

Western blots were performed to test the efficiency of immunoprecipitation as shown in FIG. 9. The One-Step complete IP western method is able to block the bands coming from antibody itself (which are expected to be at 25 KDa (light chain) and 55 KDa (heavy chain), and the only bands visible in the IP sample are expected to be coming from the target protein. For comparison, 200 ng of each antibody was included on the gel. As shown in FIG. 9, panel A; IPs done with sc-100746 and ab55138 show two bands at around 50 and 70 KDa which are not present in the lanes corresponding to antibody only. To further confirm that these bands are indeed something being immunoprecipitated and are not coming from the antibody, a traditional western was done using sc-100746. As shown in FIG. 9, panel B; both 50 and 70 KDa bands are not present in lanes corresponding to either antibody, indicating that it is not simply a confounding band from the antibody but is GGT. Since GGT is known to have many isoforms, it is not surprising to see two bands of different molecular weights in the IP.

### Example 7

### Microarray Sample Prep

About 250 ng RNA recovered from the immunoprecipitations was analyzed on Affymetrix Human Gene ST 1.0 arrays. The RNA was first converted to double stranded cDNA with random hexamers tagged with a T7 promoter sequence. The double-stranded cDNA is subsequently used as a template and amplified by T7 RNA polymerase producing many copies of antisense cRNA. In the second cycle of cDNA synthesis, random hexamers are used to prune reverse transcription of the cRNA from the first cycle to produce single-stranded DNA in the sense orientation. In order to reproducibly fragment the single-stranded DNA and improve the robustness of the assay, a novel approach is utilized where dUTP is incorporated in the DNA during the second-cycle, first-strand reverse transcription reaction. This single-stranded DNA sample is then treated with a combination of uracil DNA glycosylase (UDG) and apurinic/apyrimidinic endonuclease 1 (APE 1) that specifically recognizes the unnatural dUTP residues and breaks the DNA strand. DNA is labeled by terminal deoxynucleotidyl transferase (TdT) with the Affymetrix® proprietary DNA Labeling Reagent that is covalently linked to biotin.

The biotinylated fragments are then hybridized over 16 h to the Human Gene 1.0 ST arrays, wash stained and scanned on a GeneChip 3000 system.

The CEL files from the scanner were analyzed using GeneSpring GX (v10) software. The raw data was quantile normalized using Affymetrix's iterPLIER algorithm and the normalized data was further filtered on expression values to exclude the bottom 20^{th} percentile of transcripts that showed poor or no expression in all samples. This list was then used to select for transcripts that are differentially expressed at a 1.5 fold change between any two conditions (GGT IP vs input; GGIP vs G10 IP). When we look at the microarray data from input and IP, the input (or total) represents the complete transcriptome of the cell (all the mRNAs present in the cell). Out of this, it is expected that only some mRNAs to co-IP with GGT and those are expected to be enriched in the IP when compared with the input.

The negative control is an IP with G10 antibody in parallel using the same lysate. G10 is the coat protein of bacteriophage T7 (gene 10 or g10-L) and is completely unrelated to any human protein.

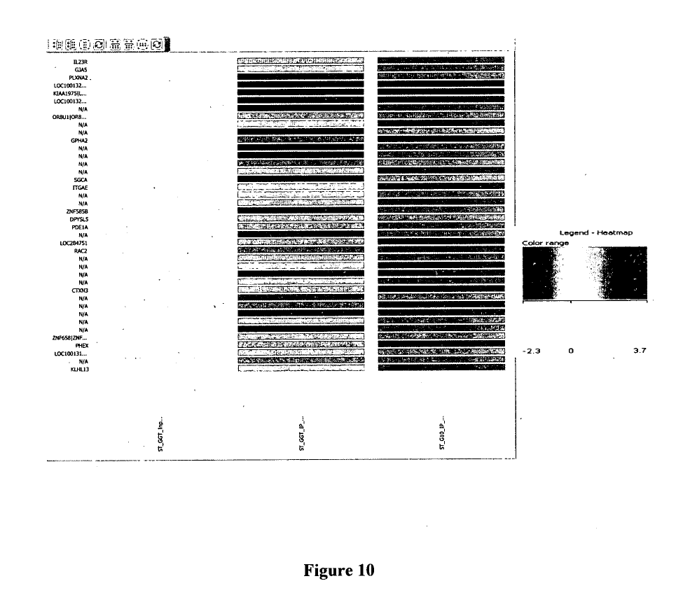

A list of genes was then created from these comparisons to include transcripts that were selectively enriched in GGT IP as compared to both the input and the G10 1P sample (Table 1 & FIG. 10).

TABLE 1

| | Fold | Fold | ST_G10_IP_{—} | ST_GGT_IP_{—} | ST_GGT_IP_{—} |
|---|---|---|---|---|---|
| Transcripts | Change | change | 12292008.CEL | 12292008.CEL | 12292008.CEL |
| Cluster Id | wrt input | wrt G10 | (normalized) | (normalized) | (normalized) |
| | | 39.0 | | | |
| 7939418 | 22.37 | 3 | −0.80274 | 4.483616 | 0 |
| | | 13.6 | | | |
| 7957476 | 8.46 | 8 | −0.69355 | 3.080821 | 0 |
| | | 10.0 | | | |
| 8036389 | 6.10 | 0 | −0.71299 | 2.608308 | 0 |
| 7947740 | 3.86 | 5.87 | −0.60417 | 1.948091 | 0 |
| 7967792 | 3.78 | 6.29 | −0.73301 | 1.919052 | 0 |
| 8121273 | 3.65 | 7.39 | −1.01521 | 1.869506 | 0 |
| | | 10.0 | | | |
| 7927363 | 3.62 | 1 | −1.4688 | 1.854146 | 0 |
| 7933423 | 3.61 | 9.83 | −1.44454 | 1.853157 | 0 |
| 7933327 | 3.61 | 9.85 | −1.44897 | 1.851025 | 0 |
| 8093683 | 3.32 | 6.39 | −0.94565 | 1.731048 | 0 |
| 8156519 | 3.29 | 5.73 | −0.79968 | 1.718904 | 0 |
| 8008277 | 3.07 | 4.66 | −0.60166 | 1.618836 | 0 |
| 8058693 | 2.90 | 4.70 | −0.69457 | 1.537663 | 0 |
| 7923991 | 2.69 | 4.22 | −0.65231 | 1.424948 | 0 |
| 8109303 | 2.68 | 4.21 | −0.64999 | 1.422259 | 0 |
| 8075910 | 2.26 | 4.14 | −0.87473 | 1.176329 | 0 |
| 8121269 | 2.25 | 4.75 | −1.0801 | 1.167813 | 0 |
| 7993165 | 2.20 | 3.42 | −0.63895 | 1.134224 | 0 |
| 7949320 | 2.17 | 4.51 | −1.05649 | 1.115813 | 0 |
| 8169638 | 2.06 | 3.46 | −0.74669 | 1.044708 | 0 |
| 8063389 | 1.83 | 3.92 | −1.09758 | 0.871739 | 0 |
| 8166408 | 1.83 | 3.70 | −1.01983 | 0.869028 | 0 |
| 8057486 | 1.78 | 2.92 | −0.71912 | 0.829295 | 0 |
| 7939983 | 1.76 | 2.77 | −0.65664 | 0.812532 | 0 |
| 8107764 | 1.75 | 3.58 | −1.03228 | 0.806299 | 0 |
| 8040725 | 1.73 | 2.64 | −0.61033 | 0.788628 | 0 |
| 7902189 | 1.73 | 3.02 | −0.80918 | 0.787599 | 0 |
| 8080985 | 1.70 | 2.96 | −0.80106 | 0.766115 | 0 |
| 7998835 | 1.68 | 3.07 | −0.8656 | 0.750958 | 0 |
| 8161319 | 1.67 | 2.59 | −0.63305 | 0.741831 | 0 |
| 8022870 | 1.67 | 2.99 | −0.84286 | 0.737335 | 0 |
| 8100941 | 1.64 | 2.85 | −0.79325 | 0.717683 | 0 |
| 8166712 | 1.64 | 2.56 | −0.63648 | 0.717216 | 0 |
| 8154868 | 1.64 | 2.72 | −0.72759 | 0.714283 | 0 |
| 7919340 | 1.59 | 2.67 | −0.74441 | 0.671888 | 0 |
| 8020666 | 1.58 | 2.55 | −0.68885 | 0.663613 | 0 |
| 8011430 | 1.58 | 2.99 | −0.91978 | 0.662635 | 0 |
| 7942912 | 1.56 | 2.80 | −0.84807 | 0.63697 | 0 |
| 8174654 | 1.55 | 2.85 | −0.87903 | 0.633493 | 0 |
| 8082246 | 1.51 | 4.15 | −1.46323 | 0.590127 | 0 |

The list of genes identified by microarray is presented in the table 2 below. Thus, it is confirmed that GGT has bound the mRNA of these genes and GGT is indeed an RNA binding protein.

TABLE 2

| | Fold change | Fold change | |
|---|---|---|---|
| | compared to | compared to | |
| Gene Symbol | input | G-10 | Gene Description |
| ZNF585B | 6.10 | 10.00 | Zinc finger protein 585 B. Zinc |
| | | | finger domains are often found in |
| | | | transcriptional regulators, no |
| | | | further information is currently |
| | | | available about this protein. |
| KIAA1975 | 3.61 | 9.85 | AGAP11, this protein has ankyrin |
| | | | repeats and GTPase activating |
| | | | activity. |
| SGCA | 3.07 | 4.66 | Sarcoglycal alpha, This gene |
| | | | encodes a component of the |
| | | | dystrophin-glycoprotein complex |
| | | | (DGC), which is critical to the |
| | | | stability of muscle fiber |
| | | | membranes and to the linking of |
| | | | the actin cytoskeleton to the |
| | | | extracellular matrix. Mutations in |
| | | | this gene result in type 2D |
| | | | autosomal recessive limb-girdle |
| | | | muscular dystrophy. |
| PLXNA2 | 2.69 | 4.22 | Plexin A2. This gene encodes a |
| | | | member of the plexin-A family of |
| | | | semaphorin co-receptors. |
| | | | Semaphorins are a large family of |
| | | | secreted or membrane-bound |
| | | | proteins that mediate repulsive |
| | | | effects on axon pathfinding during |
| | | | nervous system development. |
| RAC2 | 2.26 | 4.14 | ras-related C3 botulinum toxin |
| | | | substrate 2. The protein encoded |
| | | | by this gene is a GTPase which |
| | | | belongs to the RAS superfamily of |
| | | | small GTP-binding proteins. |
| | | | Members of this superfamily |
| | | | appear to regulate a diverse array |
| | | | of cellular events, including the |
| | | | control of cell growth, cytoskeletal |
| | | | reorganization, and the activation |
| | | | of protein kinases. |
| GPHA2 | 2.17 | 4.51 | Glycoprotein hormone alpha 2. |
| | | | GPHA2 is a cystine knot-forming |
| | | | polypeptide and a subunit of the |
| | | | dimeric glycoprotein hormone |
| | | | family |
| PHEX | 1.83 | 3.7 | Phosphate regulating |
| | | | endopeptidase homolog, X-linked. |
| | | | The protein encoded by this gene |
| | | | is a transmembrane endopeptidase |
| | | | that belongs to the type II integral |
| | | | membrane zinc-dependent |
| | | | endopeptidase family. The protein |
| | | | is thought to be involved in bone |
| | | | and dentin mineralization and |
| | | | renal phosphate reabsorption. |
| PDE1A | 1.78 | 2.92 | Phosphodiesterase 1A, calmodulin- |
| | | | dependent. Phosphodiesterases are key |
| | | | enzymes that play a pivotal role in |
| | | | mediating the cross-talk between cAMP |
| | | | and Ca2+ signalling. |
| OR8U1 | 1.76 | 2.77 | Olfactory receptor, family 8 |
| CTXN3 | 1.75 | 3.58 | Cortexin 3, it may be involved in a |
| | | | process specifically restricted to kidney |
| | | | and brain tissue function. |
| DPYSL5 | 1.73 | 2.64 | Dihydropyrimidinase like, Members of |
| | | | this family, are believed to play a role in |
| | | | growth cone guidance during neural |
| | | | development |
| IL23R | 1.73 | 3.02 | IL23 receptor. The protein encoded by |
| | | | this gene is a subunit of the receptor for |
| | | | IL23A/IL23. It associates constitutively |
| | | | with Janus kinase 2 (JAK2), and also |
| | | | binds to transcription activator STAT3 in |
| | | | a ligand-dependent manner. |
| ZNF658 | 1.67 | 2.59 | Zinc finger protein 658. Zinc finger |
| | | | domains are often found in transcriptional |
| | | | regulators, no further information is |
| | | | currently available about this protein. |
| GJA5 | 1.59 | 2.67 | Gap junction protein alpha 5. This gene |
| | | | is a member of the connexin gene family. |
| | | | The encoded protein is a component of |
| | | | gap junctions, which are composed of |
| | | | arrays of intercellular channels that |
| | | | provide a route for the diffusion of low |
| | | | molecular weight materials from cell to |
| | | | cell. Mutations in this gene may be |
| | | | associated with atrial fibrillation. |
| ITGAE | 1.58 | 2.99 | Integrin alpha E. In combination with the |
| | | | beta 7 integrin, this protein forms the E- |
| | | | cadherin binding integrin the human |
| | | | mucosal lymphocyte-1 antigen. This |
| | | | protein is preferentially expressed in |
| | | | human intestinal intraepithelial |
| | | | lymphocytes (IEL), and in addition to a |
| | | | role in adhesion, it may serve as an |
| | | | accessory molecule for IEL activation. |
| KLHL13 | 1.55 | 2.89 | Kelch like protein. No information about |
| | | | its function is currently available. |

We claim:

1) A method to characterize a protein as RNA-binding protein, said method comprising steps of:
a) modeling the protein using a template structure;
b) analyzing the modeled protein for RNA-binding site(s); and
c) docking the analyzed modeled protein with polyadenylated RNA using co-ordinates of RNA complexed with polyadenine binding protein for said characterisation.

2) The method as claimed in claim 1, wherein the protein is modeled using modeling tools and servers, preferably jigsaw “interactive server”.

3) The method as claimed in claim 1, wherein the modeled protein is analyzed for RNA-binding site(s) using Rbind software.

4) The method as claimed in 1, wherein the method is useful in identifying RNA's that bind the protein which may prove useful as biomarkers or drug targets.

5) The method as claimed in claim 1, wherein the method is useful in early stage detection and/or classification of cancer.

6) A method to characterize Gamma-glutamyl transpeptidase (GGT) as RNA-binding protein, said method comprising steps of:
a) modeling the GGT using a template structure;
b) analyzing the modeled GGT for RNA-binding site(s); and
c) docking the analyzed modeled GGT with polyadenylated RNA using co-ordinates of RNA complexed with polyadenine binding protein for said characterisation.

7) The method as claimed in claim 6, wherein the template structure is 2DG5 and its orthologs.

8) The method as claimed in claim 6, wherein the GGT is modeled using modeling tools and servers, preferably jigsaw “interactive server”.

9) The method as claimed in claim 6, wherein the modeled GGT is analyzed for RNA-binding site(s) using Rbind software.

10) The method as claimed in claim 6, wherein the RNA-binding site is present in light chain of GGT.

11) The method as claimed in claim 6, wherein the RNA-binding sites are arginine rich motifs of the light chain of GGT.

12) The method as claimed in claim 6, wherein the co-ordinates of RNA alone was taken from the structure ICVJ.

13) The method as claimed in 6, wherein the method is useful in identifying RNA's that bind the GGT which may prove useful as biomarkers or drug targets.

14) The method as claimed in claim 6, wherein the method is useful in early stage detection and/or classification of cancer.

15) A method to identify RNA's bound to GGT as useful biomarkers or drug targets, said method comprising steps of:
a) modeling the GGT using a template structure;
b) analyzing the modeled GGT for RNA-binding site(s); and
c) docking the analyzed modeled GGT with polyadenylated RNA's to identify the RNA's as useful biomarkers or drug targets;

16) The method as claimed in claim 15, wherein the analyzed modeled GGT is docked with polyadenylated RNA's using co-ordinates of RNA complexed with a known polyadenine binding protein.
